(19) United States
(12) Patent Application Publication
(10) Pub. No.: US 2015/0331837 A1
(43) Pub. Date: Nov. 19, 2015

(54) TEXT PROCESSING METHOD AND MOBILE TERMINAL

(71) Applicant: TENCENT TECHNOLOGY (SHENZHEN) COMPANY LIMITED, Shenzhen (CN)

(72) Inventor: TAISHEN PAN, Shenzhen (CN)

(73) Assignee: TENCENT TECHNOLOGY (SHENZHEN) COMPANY LIMITED

(21) Appl. No.: 14/811,042

(22) Filed: Jul. 28, 2015

Related U.S. Application Data
(63) Continuation of application No. PCT/CN2013/088943, filed on Dec. 10, 2013.

(30) Foreign Application Priority Data
May 2, 2013 (CN) 2013-10159473.1

(51) Int. Cl. G06F 17/21; G06F 17/22

(52) U.S. Cl. CPC G06F 17/212; G06F 17/227

(57) ABSTRACT

The present disclosure relates to a text processing method and a mobile terminal. The method includes: detecting whether a fine feed boundary state pn which line feed is caused by a last character and a last line is occupied by the character occurs in the text paragraph of the mobile terminal; applying a preset property to the text paragraph of the mobile terminal if the line feed boundary state occurs in the text paragraph of the mobile terminal; and otherwise, skipping applying the preset property. By using the present disclosure, a situation in which a last symbol individually occupies one line of the text paragraph is avoided, mobile version resources of a mobile terminal is saved, and a visual effect of the mobile terminal is improved.

### RELATED APPLICATION

This application is a continuation application of PCT patent application no. PCT/CN2013/088943, filed on Dec. 10, 2013, which claims priority to Chinese Patent Application No. 201310159473.1, filed with the Chinese Patent Office on May 2,2013 and entitled “TEXT PROCESSING METHOD AND MOBILE TERMINAL,” the content of all of which is incorporated by reference in its entirety.

### FIELD OF THE TECHNOLOGY

The present disclosure relates to the technical field of mobile Internet, and in particular, to a text processing method and a mobile terminal.

### BACKGROUND OF THE DISCLOSURE

In the current mobile Internet, for mobile versions of major social networking sites (for example, Qzone, facebook, twitter, and google+), word rendering in the mobile versions of the social networking sites is mostly presented as feeds (such as friend's updates and latest news) due to the size restraint of mobile phone screens. Generally, a list of several latest feeds are used as a homepage.

A mobile version of facebook (m.facebook.com) is used as an example. After logging in the m.facebook.com, a homepage is presented, as shown in FIG. 1-1. A text in a box in FIG. 1-1 is used as an example. The text is put in a DIV element as a paragraph and is displayed in a display area defined by the DIV element. The DIV element is an element for providing a structure and a background for block-level content in an HTML file. Entire content between a start tag and an end tag of the DIV is used for composing the block. Element characteristics included in the DIV is controlled by properties of DIV tags, or is controlled by formatting the block by using a style sheet.

For a block-level element such as a DIV, a normal word (Asian characters and non-Asian characters) line feed element has default white-space: normal (white-space default processing method: automatic text processing and line feed). That is, automatic line feed is performed after a defined width is exceeded and a character is not broken. The expression “a character is not broken” refers to that one English word is not displayed in two lines. In addition, by using this line feed method, a punctuation mark does not appear at a head of a certain line. The punctuation mark and one word before the punctuation mark may compose an integral whole, which presents characteristics of an English word. That is, the last two characters “Ha” and “!” in the box in FIG. 1-1 do not appear in two lines. For example, they are both in the second line, or are both in the third line. A case in which individually appears in the third line does not occur.

At present, the major social networking sites often use the foregoing solution to implement the word rendering in the mobile versions. However, the foregoing solution has the following disadvantages, a line feed boundary state (that is, a situation in which a last character, for example, a punctuation mark, of a paragraph of words cannot be put in a previous line, which causes line feed, and a last line is occupied, by the character) may occur in the following two situations.

(1) Ordinary line feed characteristics may be violated when some special symbols are used as tails of texts. A situation in which one symbol occupies one line occurs, for example, a tilde “˜”, as shown in FIG. 1-2. In a touch version Ozone homepage in FIG. 1-2, the tilde in the box individually occupies one line.

(2) To prevent successive characters from flowing over an area defined by a DIV element due to limitation of the display area defined by the DIV element, sometimes word-wrap: break-word (word-wrap is allowed and any wordbreak. of a non-Asian language text is allowed according to text rules of Asian and non-Asian languages) or word-breakbreak-all (content line feed is within a boundary and if necessary, word-wrap is also allowed) may be set for a text element. After the settings, a situation in which one symbol occupies one line may also occur, as shown in FIG. 1-3. In a touch version Qzone homepage, one dot of an apostrophe in the box individually occupies one line.

However, a display interface of a mobile terminal is quite limited. A generated line feed boundary state not only affects visual effect, but also causes that a single FFED (concise information aggregation content) occupies an excessively large display area during presentation and impacts presentation of other valuable information to a user, thus resulting in waste of display area resources of the mobile terminal.

### SUMMARY

In view of the above, embodiments of the present invention provide a text processing method and a mobile terminal, with an objective of preventing occurrence of a line feed critical state of a text and saving display interface resources of the mobile terminal.

The present disclosure provides a text processing method, including acquiring a text paragraph input on a mobile terminal; detecting whether a line feed boundary state in which line feed is caused by a last character and a last line is occupied by the character occurs in the text, paragraph when displaying the text paragraph in a set display area; and applying a preset property to the text paragraph to remove the line feed boundary state if the line teed boundary state occurs in the text paragraph.

The present disclosure further provides a mobile terminal, including an acquiring module configured to acquire a text paragraph input on the mobile terminal; a detecting module configured to detect whether a line feed boundary state in which line feed is caused by a last character and a last line is occupied by the character occurs in the text paragraph when displaying the text paragraph in a set display area; and a processing module configured to apply a preset property to the text paragraph to remove the line feed boundary state if the line feed boundary state occurs in the text paragraph.

In the text processing method and the mobile terminal provided in the present disclosure, by acquiring a text paragraph input on the mobile terminal, detecting whether a line feed boundary state occurs in the text paragraph when displaying the text paragraph in a set display area, and applying a preset property to the text paragraph to remove the line feed boundary state if the line feed boundary state occurs in the text paragraph, a situation in which a last symbol individually occupies one line of the text paragraph is avoided, display interface resources of the mobile terminal are saved, limitation to information showing of existing mobile terminals is also avoided, and a visual effect of the mobile terminal is improved.

### BRIEF DESCRIPTION OF THE DRAWINGS

To describe the technical solutions of the present disclosure more clearly and comprehensively, the following describes in detail with reference to the accompanying drawings.

FIG. 1-1 is a schematic diagram of a homepage of a mobile version of facebook of the existing technology:

FIG. 1-2 is a schematic diagram of a Qzone homepage of a touch version of the existing technology;

FIG. 1-3 is a schematic diagram of occurrence of a line feed boundary state in a Qzone homepage of a touch version of the existing technology;

FIG. 2 is a schematic flowchart of a first embodiment of a text processing method of the present disclosure;

FIG. 3 is a schematic flowchart of a second embodiment of the text processing method of the present disclosure;

FIG. 4-1 is a schematic diagram before using a solution of the embodiments of the present invention in an ordinary text paragraph in which a line feed boundary state does not occur;

FIG. 4-2 is a schematic diagram after using the solution of the embodiments of the present invention in the ordinary text, paragraph in which the line feed boundary state does not occur shown in FIG. 4-1;

FIG. 4-3 is a schematic diagram before using a solution of the embodiments of the present invention in an ordinary text paragraph in which a line feed boundary state occurs;

FIG. 4-4 is a schematic diagram after using the solution of the embodiments of the present invention in the ordinary text paragraph in which the line feed boundary state occurs;

FIG. 5 is a schematic flowchart of a third embodiment of the text processing method of the present, disclosure;

FIG. 6 is a schematic flowchart of a fourth embodiment, of the text processing method of the present disclosure;

FIG. 7 is a schematic flowchart of screening a text paragraph currently input on a mobile terminal and acquiring a text paragraph that meets a processing condition in the embodiments of the text processing method of the present disclosure;

FIG. 8 is a schematic structural diagram of a first embodiment of a mobile terminal of the present disclosure;

FIG. 9 is a schematic structural diagram of a detecting module in the embodiment of the mobile terminal of tile present disclosure;

FIG. 10 is another schematic structural diagram of the detecting module in the embodiment of the mobile terminal of the present disclosure;

FIG. 11. is a schematic structural diagram of a second embodiment of the mobile terminal of the present disclosure; and

FIG. 12 is a schematic structural diagram of a screening module in an embodiment of the mobile terminal of the present disclosure.

### DESCRIPTION OF EMBODIMENTS

A technical solution of embodiments of the present invention is: by acquiring a text paragraph input on a mobile terminal detecting whether a line feed boundary state occurs in the text paragraph of the mobile terminal by applying a CSS property in the text paragraph of the mobile terminal or by using a character string interception method, and applying the CSS property in the text paragraph to remove the line feed boundary state if the line feed boundary state occurs in the text paragraph, a situation in which a last symbol individually occupies one line of the text paragraph is avoided, display interface resources of the mobile terminal are saved, and limitation to information showing of existing mobile terminals is also avoided.

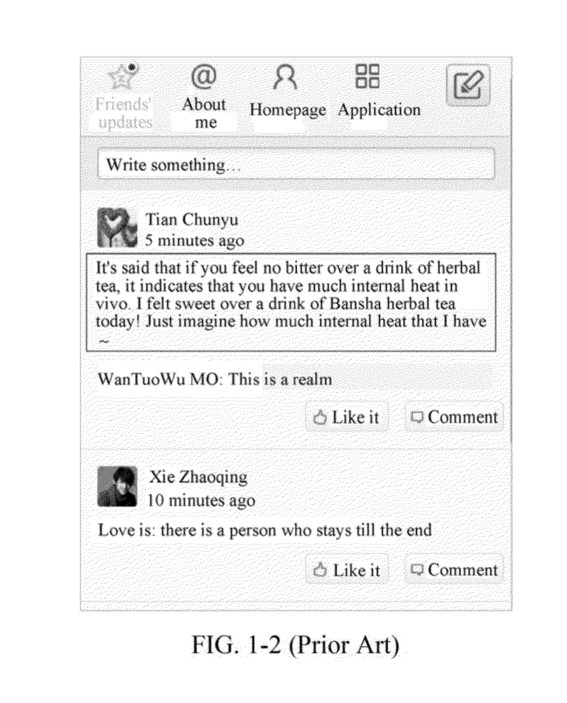

As shown in FIG. 2, a first embodiment of the present invention provides a text processing method, which includes:

Step S90: Acquire a text paragraph input on a mobile terminal.

Step S101: Detect whether a line feed boundary state occurs in the text paragraph when displaying the technical paragraph in a set display area; if the line feed boundary state occurs in the text paragraph, enter step S102; and if the line feed boundary state does not occur in the text paragraph, enter step S103.

The embodiment of the present invention mostly relates to word rendering and line feed method in mobile version of a social networking site and handles a situation in which a last symbol of a text paragraph, in particular, a Chinese text paragraph, individually occupies one line.

The text paragraph is placed in one DIV element and is displayed in a display area

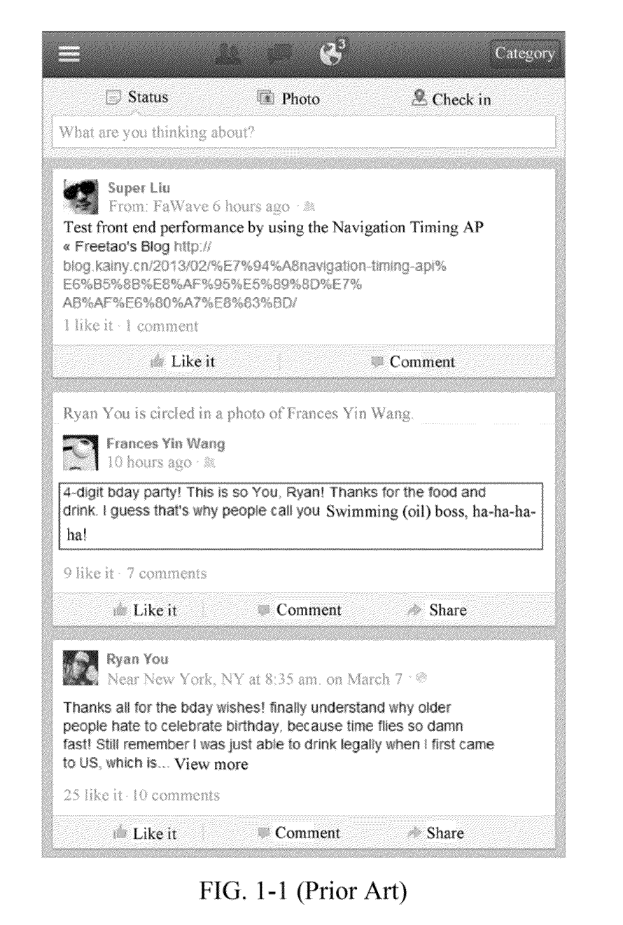

defined by one DIV element in a display interface of the mobile terminal (that is, the referred, set display area in this embodiment). Generally, word-wrap is performed when a text in a DIV element exceeds a width defined by the DIV element and a character is not broken. As described above, ordinary line feed characteristics may be voided when some special symbols are used as tails of texts. A situation in which one symbol occupies one line occurs, for example, a tilde as shown, in FIG. 1-2. In addition, a situation in which one symbol occupies one line may also occur when word-wrap: break-word or word-break: break-all is set for a text element, as shown in FIG. 1-3.

Therefore, it is necessary to detect whether a line feed boundary state occurs in a text, paragraph of a mobile terminal. The mobile terminal may be a mobile device such as a mobile phone or a tablet computer.

The foregoing line feed boundary state refers to a situation in which a last character of a paragraph of words cannot be put in a previous line, which causes line feed, and a last line is occupied by the character.

As an implementation, the method for detecting whether a line feed boundary state occurs in a text paragraph of a mobile terminal may use the following method:

The length and the number of words in a last line of a segment of text cannot be obtained from an HTML, a CSS, or an original API of a Javascript. One method of this embodiment is detecting whether a line feed boundary state occurs in a text paragraph by using a hypothesis method. If the line feed boundary state occurs in a certain segment, of text currently, it is further assumed that there is a method A for removing the line feed boundary state. One property of the segment of text, the height, changes before and after the use of the method A. Therefore, it can be obtained from this embodiment that the method for detecting a line feed boundary state is: a method A is applied to a text paragraph; if the height of the text, changes, it indicates the line feed boundary state occurs in the text paragraph; and otherwise, the line feed boundary state does not occur in the text paragraph.

Meanwhile, to handle the situation in which a last symbol individually occupies one line of the text paragraph, the line feed boundary state of the text paragraph is removed after the method A is applied.

In consideration of the fixed width of the text, the need of putting the last symbol of the text paragraph to a previous Sine can be implemented by compressing letter-spacing of the text. In this embodiment, a CSS property is used in the text paragraph to detect whether the line feed boundary state occurs in the text paragraph.

Cascading Style Sheets (CSS) are a mark language for representing file styles such as an HTML or an XML and allow separation between style information and webpage content. For example, it is a style to make a link word be blue when it is not clicked and change into red with an underline after mouse-over. By creating style sheets, display properties of all marks in the HTML or the XML may be controlled uniformly, and capabilities of precisely designating a webpage element, position or appearance, and creating a special effect are expanded.

A letter-spacing property in the CSS is used as an example. The Letter-spacing defines a space that is inserted between text, character boxes. Because a character font, is generally narrower than a character box, a general interval, between letters may be adjusted when a length value is designated. A default value of the interval generally is 0.

Words of the text paragraph may become more compact by setting a letter-spacing property value to be a specific negative value, thus clearing a space for accommodating more content and removing a line feed boundary state of the text paragraph. For example, the letter-spacing property value maybe set to be −1 pixel (px), which is a minimum value, so as to prevent the words from being excessively compact and influencing reading, in addition, the space cleared by making the letter-spacing property value be −1 px is very small, and thus can only accommodate one punctuation mark, which actually satisfies requirements of the method A of this embodiment. The letter-spacing: −1 px is applied to the text paragraph. If the height of the text paragraph changes, it indicates that the line feed boundary state occurs; and otherwise, the line feed boundary state does not occur in the text paragraph. Therefore, whether the line feed boundary state occurs is determined by determining whether a property of the text paragraph changes.

As another implementation, whether a line feed boundary state occurs in a text paragraph may be also detected by using a character string extraction method. For example, in s=str,substr(0.length−1), str is an original character string, and s is anew character string after a last character of the text paragraph is removed. Whether the height of the character string str is equal to the height of s is detected. If a change occurs before and after the removal, it indicates that, the line feed boundary state occurs in the text paragraph, and otherwise, it indicates that the line feed boundary state does not occur in the text paragraph.

Step S102: Apply a preset property in the text paragraph to remove the line feed boundary state.

Step S103: Skip applying the preset property in the text paragraph.

If it is detected that the line feed boundary state occurs in the text paragraph, the line feed boundary state of the text paragraph is removed by applying the preset property to the text paragraph. If occurrence of the line feed boundary state in the text paragraph is not detected, the preset property does not need to be applied to the text paragraph.

The preset property may be a CSS property. For example, a letter-spacing property value or a Word-spacing property value of the text paragraph is a set negative value, for example, −1 pixel (px), so as to make words of the text paragraph be more compact, thereby clearing a space for accommodating more content and removing the line feed boundary state of the text paragraph.

In the implementation of detecting whether the line feed boundary state occurs in the text paragraph by using the CSS property, if it is detected that the line feed boundary state occurs in the text paragraph, the CSS property applied to the text paragraph is retained to remove the line feed boundary state of the text paragraph. If it is detected that the line feed boundary state does not occur in the text paragraph, the CSS property applied to the text paragraph is removed.

In this embodiment, by detecting whether a line feed boundary state occurs in a text paragraph of a mobile terminal and applying a preset property to the text paragraph of the mobile terminal to remove the line feed boundary state if the line feed boundary state occurs in the text paragraph of the mobile terminal, a situation in which a last symbol individually occupies one line of the text paragraph is avoided, display interlace resources of the mobile terminal are saved, and limitation to information showing of existing mobile terminals is also avoided.

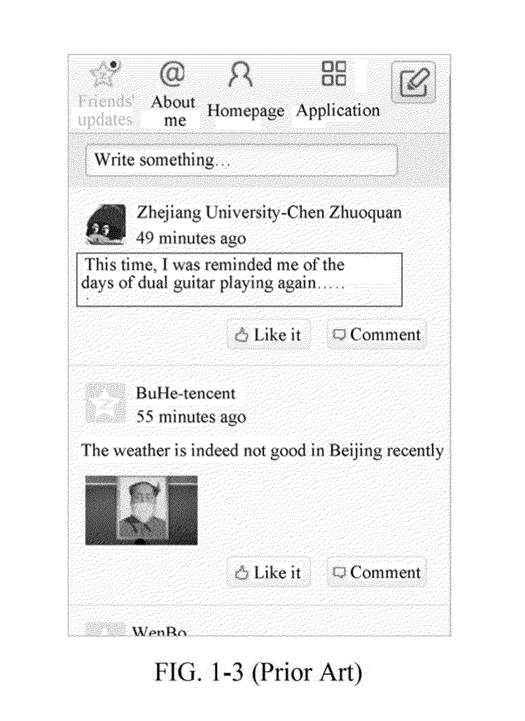

As shown in FIG. 3, a second embodiment of the present invention provides a text processing method, which includes:

Step S90: Acquire a text paragraph input on a mobile terminal

Step S1011: Set a CSS property for the text paragraph of the mobile terminal.

As compared with the first embodiment; in this embodiment, whether a line feed boundary state occurs in the text paragraph is detected by directly setting a CSS property for the text paragraph.

In consideration of the fixed width of the text and the need of putting the last symbol of the text paragraph to a previous line, a situation in which a last symbol individually occupies one line may be handled by compressing letter-spacing of the text.

In this embodiment, a CSS property is used in the text paragraph to detect whether the line feed boundary state occurs in the text paragraph.

Step S1012: Detect whether the height of the text paragraph changes after the CSS property is set; if the height changes, enter step S1013; and otherwise, enter step S1014.

Step S1013: Determine that the line feed boundary state occurs in the text paragraph; and enter step S1021.

Step S1014; Determine that the line feed boundary state does not occur in the text paragraph; and enter step S1022.

The letter-spacing property in the CSS is used as an example, words of the text paragraph may become more compact by setting a letter-spacing property value to be a specific negative value, thus clearing a space for accommodating more content and removing a line feed boundary state of the text paragraph. For example, the letter-spacing property value may be set to be −1 pixel (px), which is a minimum value, so as to prevent the words from being excessively compact and influencing reading. In addition, the space cleared by making the letter-spacing property value be −1 px is very small, and thus can only accommodate one punctuation mark, thereby handling a situation in which a last symbol individually occupies one line of the text paragraph to remove the line feed boundary state of the text paragraph.

During detection, the letter-spacing: −1 px is applied to the text paragraph, if the height of the text paragraph changes, it indicates that the line feed boundary state occurs in the text paragraph; and otherwise, the line feed boundary state does not occur in the text paragraph. Therefore, whether the line feed boundary state occurs is determined by determining whether a property of the text paragraph changes.

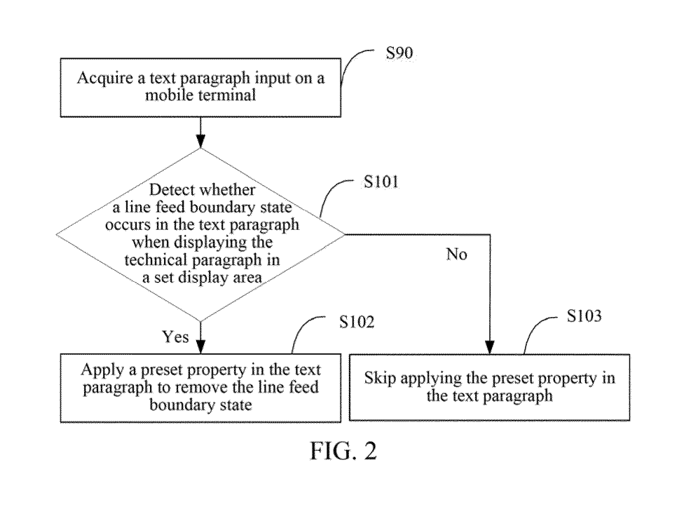

As shown in FIG. 4-1, FIG. 4-1 is an ordinary text paragraph in which a line feed boundary state does not occur. The height does not change if the letter-spacing: −1 px is applied to the text paragraph, as shown in FIG. 4-2.

As shown in FIG. 4-3, FIG. 4-3 is an ordinary text paragraph in which a line feed boundary state occurs. The height changes if the letter-spacing: −1 px is applied to the text paragraph, as shown in FIG. 4-4, The final tilde is placed, in a previous line and the whole text does not seem to be very compact, either.

Besides, the letter-spacing property in the implementation may be replaced with a Word-spacing property in the CSS in some situations. The Word-spacing defines the number of blank characters that are inserted between words in a text element. With respect to the property, “word” is defined as a character string surrounded by blank characters. If a length value is designated, a general interval between words may be adjusted. A default value of the interval is generally set to be 0.

The Word-spacing is a CSS property similar to the letter-spacing. The difference between the Word-spacing and the letter-spacing is: what is defined by the letter-spacing is a space between characters and what is defined by the Word-spacing is a space between characters (words). For pure Chinese, because there is not a blank character between Chinese characters, the Word-spacing has no effect on the Chinese. Therefore, only the letter-spacing can be used in a condition of pure Chinese.

Step S1021: Retain the CSS property in the text paragraph.

Step S1022: Remove the CSS property from the text paragraph.

If it is detected that the line feed boundary state occurs in the text paragraph, the CSS applied to the text paragraph is retained to remove the line feed boundary state of the text paragraph. If occurrence of the line feed boundary state in the text paragraph is not detected, the CSS property applied to the text paragraph is removed.

In this embodiment, by detecting whether a line feed boundary state occurs in a text paragraph of a mobile terminal, by setting a CSS property for the text paragraph of the mobile terminal, retaining the CSS property in the text paragraph of the mobile terminal if the line feed boundary state occurs in the text paragraph of the mobile terminal, and otherwise, removing the applied CSS property, a situation in which a last symbol individually occupies one line of the text paragraph is avoided, display interface resources of the mobile terminal are saved, and limitation to information showing of existing mobile terminals is also avoided.

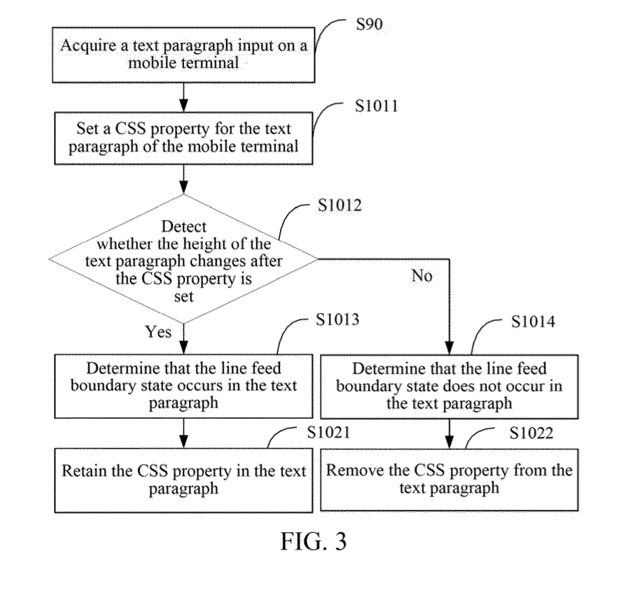

As shown in FIG. 5, a third embodiment of the present invention provides a text processing method, which includes:

Step S90: Acquire a text paragraph input on a mobile terminal.

Step S1015; Perform extraction processing on the last character of the text paragraph.

Step S1016: Detect whether the height of the text, paragraph changes after the character extraction processing; if the height changes, enter step S1017; and otherwise, enter step S1018.

Step S1017: Determine that, the line feed boundary state occurs in the text paragraph; and enter step S1023.

Step S1018: Determine that the line feed boundary state does not occur in the text paragraph; and enter step S1024.

As compared with the first embodiment, in this embodiment, whether the line feed boundary state occurs in the text paragraph is detected by directly using a character string extraction method. For example, make s=str.substr(0,str.length−1), str is an original character string corresponding to the text paragraph, and s is a new character string after a last character of the text paragraph is removed. Whether the height of the character string str is equal to the height of s is detected. If a change occurs before and after the removal, it indicates that the line feed boundary state occurs in the text paragraph, and otherwise, it indicates that the line feed boundary state does not occur in the text paragraph.

Step S1023: Set a CSS property for the text paragraph.

Step S1024; Skip setting a CSS property for the text paragraph.

If it is detected that the line feed boundary state occurs in the text paragraph, the line feed boundary state of the text paragraph is removed by applying the preset property to the text paragraph. If occurrence of the line feed boundary state in the text paragraph is not detected, the preset property does not need to be applied to the text paragraph.

The preset property may be a CSS property. The CSS property is used in consideration of a fixed width of a text and the need of putting a last symbol of the text paragraph to a previous line, so as to handle a situation In which the last symbol of the text, paragraph individually occupies one line, which may thus be implemented by compressing letter-spacing of the text. Moreover, to apply the CSS property to the text paragraph may remove the line feed boundary state of the text paragraph.

For example, a letter-spacing property value or a Word-spacing property value of the text paragraph is a set negative value, for example, −1 pixel (px), so as to make words of the text paragraph be more compact, thereby clearing a space for accommodating more content and removing the line teed boundary state of the text paragraph.

In this embodiment, by detecting whether a line feed boundary state occurs in a text paragraph of a mobile terminal by using a character string extraction method, applying a preset property to the text paragraph of the mobile terminal if the line feed boundary state occurs in the text paragraph of the mobile terminal, and otherwise, skipping applying the preset property, a situation in which a last symbol individually occupies one Sine of the text paragraph can be avoided, display interface resources of the mobile terminal are saved, and limitation to information showing of existing mobile terminals is also avoided.

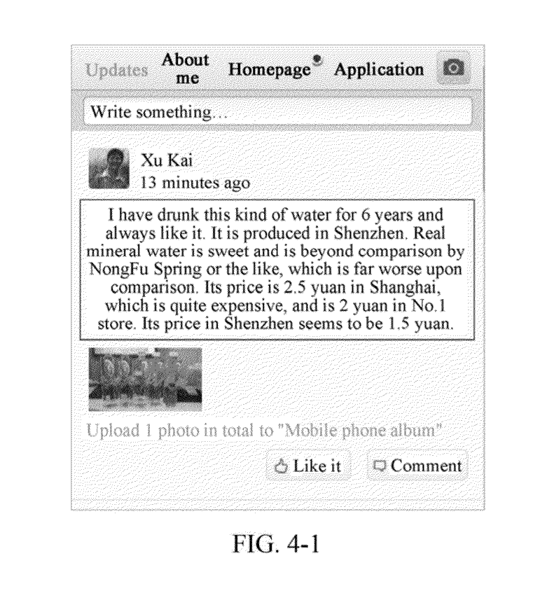

As shown in FIG. 6, a fourth embodiment of the present invention provides a text processing method. On the basis of the first embodiment, before step S101, the method former includes:

Step S100: Screen text paragraphs currently inputted on the mobile terminal, acquire a text paragraph that meets a processing condition, and use the text paragraph as a text paragraph for detecting the line feed boundary state.

As compared with the first embodiment, in this embodiment, screening farther needs to be performed on the text paragraphs to be detected before detecting whether the line feed boundary state occurs in the text input on the mobile terminal.

In this embodiment, in consideration of that not all text paragraphs are suitable to the setting of a letter-spacing property, because reading may be affected to a certain extent if a text is compact, when there are many words in M lines (M is greater than 3), this embodiment only processes a text paragraph that has a line feed boundary state and is of a predetermined N lines, for example, two to three lines (that is, a situation in which a last symbol individually occupies a second line or a third line).

A core code segment of javascript is provided below by using all p elements as an example to illustrate a process of screening text paragraphs:

//define public function getActualHeight(el)
function getCurrentHeight(el){

var padding_top =

parseInt(window.getComputedStyle(el,null).getPropertyValue(‘padding-top’));

var padding_bottom =

parseInt(window.getComputedStyle(el,null).getPropertyValue(‘padding-bottom’));

return el.clientHeight − padding_top − padding_bottom;

}
//acquire all p_tags
var p_tags = document.getElementsByTagName(‘p’);
//traverse all p_tags
for(var i=0;i<p_tags.length;i++){
var current_p = p_tags[i];
//actual height
var origin_height = getCurrentHeight(current_p);
//actual line_height

var line_height =

parseInt(window.getComputedStyle(current_p,null).getPropertyValue(‘line-height’))

//situation of two lines of words or three lines of words

if( origin_height >= line_height*2 && origin_height < line_height*3 ){

current_p.style.letterSpacing = ‘−1px’;
if(getCurrentHeight(current_p) == origin_height)

current_p.style.letterSpacing = ‘0’;

}

}

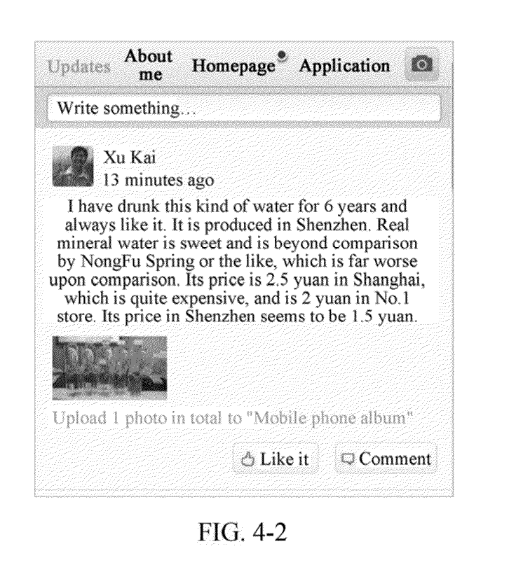

As shown in FIG. 7, as an implementation, step S100 may include:

Step S1001: Acquire all text element tags in the text paragraph currently input on tire mobile terminal.

Step S1002: Traverse all the text element tags and call a predefined public function for acquiring an actual height of an element to acquire an actual height of each text paragraph.

Step S1003; Screen out a text paragraph with the height being less than the line height of N lines, where N is an integral greater than 1.

In this embodiment, by screening text paragraphs to be detected, detecting whether a line feed boundary state occurs in the text paragraphs of the mobile terminal, applying a preset property to the text paragraph of the mobile terminal to remove the line feed boundary state if the line feed boundary state occurs in the text paragraph of the mobile terminal, and otherwise, skipping applying the preset property, a situation in which a last symbol individually occupies one line of the text paragraph is avoided, display interface resources of the mobile terminal are saved, and limitation to information showing of existing mobile terminals is also avoided.

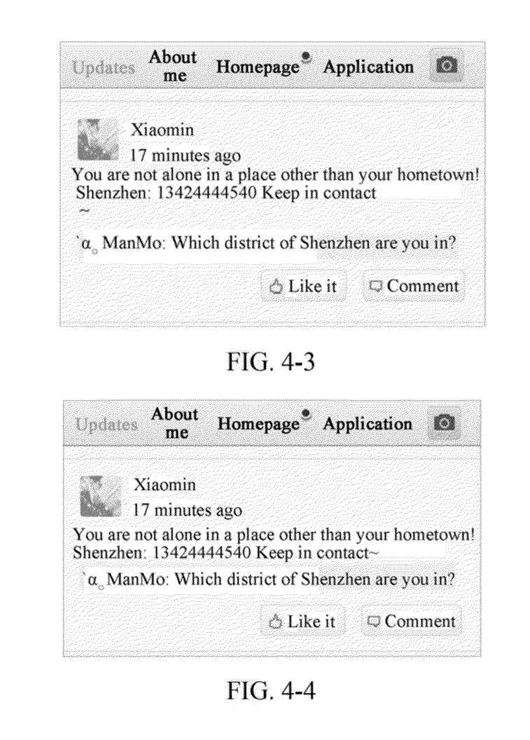

As shown in FIG. 8, a fifth embodiment of the present invention provides a mobile terminal, including: an acquiring module 200, a detecting module 201, and a processing module 202.

The acquiring module 200 is configured to acquire a text paragraph input on the mobile terminal.

The detecting module 201 is configured to detect whether a line feed boundary stale occurs in the text paragraph when displaying the text paragraph in a set display area.

The processing module 202 is configured to apply a preset property to the text paragraph to remove the line feed boundary state if the line feed boundary state occurs in the text paragraph.

The embodiment of the present invention mostly relates to word rendering and line feed method in a mobile version of a social networking site in a mobile terminal and handles a situation in which a last symbol of a text paragraph, in particular, a Chinese text paragraph, individually occupies one line.

The text paragraph is placed In one DIV element and is displayed in a display area defined by one DIV element in a display interface of the mobile terminal. Generally, word-wrap is performed when a text in a DIV element exceeds a width defined by the DIV element and a character is not broken. As described above, ordinary line Feed characteristics may be voided when some special, symbols are used as tails of texts. A situation in which one symbol occupies one line occurs, for example, a tilde as shown in FIG. 1-2. In addition, a situation in which one symbol occupies one line may also occur when word-wrap:break-word or word-break:break-all is set for a text element, as shown in FIG. 1-3.

Therefore, it is necessary to detect whether a line feed boundary state occurs in a text, paragraph of a mobile terminal. The mobile terminal may be a mobile device such as a mobile phone or a tablet computer.

The line feed boundary state refers to a situation in which a last character of a paragraph of words cannot be put in a previous line, which causes line feed, and a last line is occupied by the character.

As an implementation, the method for detecting whether a line feed boundary state occurs in a text paragraph of a mobile terminal may use the following method:

The length and the number of words in a last line of a segment of text cannot be obtained from an HTML, a CSS, or an original API of a Javascript. One method of this embodiment is detecting whether a line feed boundary state occurs in a text paragraph by using a hypothesis method, if the line feed boundary state occurs in a certain segment of text currently, it is further assumed that there is a method A for removing the line feed boundary state. One property of the segment of text, the height, changes before and after the use of the method A. Therefore, it can be obtained from this embodiment that the method for detecting a line feed boundary state is: a method A is applied to a text paragraph; if the height of the text changes, it indicates the line feed boundary state occurs in the text paragraph; and otherwise, the line feed boundary state does not occur in the text paragraph.

Meanwhile, to handle the situation in which a last symbol individually occupies one line of the text paragraph, the line feed boundary state of the text paragraph is removed after the method A is applied.

In consideration of the fixed width of the text, the need of putting the last symbol of the text paragraph to a previous line can be implemented by compressing letter-spacing of the text. In this embodiment; a CSS property is used in the text paragraph to detect whether the line feed boundary state occurs in the text paragraph.

Cascading Style Sheets (CSS) are a mark, language for representing file styles such as an HTML or an XML and allow separation between style information and webpage content. For example, it is a style to make a link word be blue when it is not clicked and change into red with an underline alter mouse-over. By creating style sheets, display properties of all marks in the HTML or the XML may be controlled uniformly, and capabilities of precisely designating a webpage element position or appearance, and creating a special effect are expanded.

A letter-spacing property in the CSS is used as an example. The Letter-spacing defines a space that is inserted between text character boxes. Because a character font is generally narrower than a character box, a general interval between letters may be adjusted when a length value is designated, A default value of the interval generally is 0.

Words of the text paragraph may become more compact by setting a letter-spacing property value to be a specific negative value, thus clearing a space for accommodating more content and removing a line feed boundary state of the text paragraph. For example, the letter-spacing property value may be set to be −1 pixel (px), which is a minimum value, so as to prevent the words from being excessively compact and influencing reading. In addition, the space cleared by making the letter-spacing property value be −1 px is very small, and thus can only accommodate one punctuation mark, which actually satisfies requirements of the method A of this embodiment. The letter-spacing: −1 px is applied to the text paragraph. If the height of the text paragraph changes, it indicates that the line feed boundary state occurs; and otherwise, the line feed boundary state does not occur in the text paragraph. Therefore, whether the line feed boundary state occurs is determined by determining whether a property of the text paragraph changes.

As another implementation, whether a line feed boundary state occurs in a text paragraph may be also detected by using a character string extraction method. For example, in s=str.substr(0.str.length−1), str is an original character string, and s is a new character string after a last character of the text paragraph is removed. Whether the height of the character string str is equal to the height of s is detected. If a change occurs before and after the removal, it indicates that the line feed boundary state occurs in the text paragraph, and otherwise, it indicates that the line feed boundary state does not occur in the text paragraph.

If the detecting module 201 detects that the line feed boundary state occurs in the text paragraph, the processing module 202 applies a preset property in the text paragraph to remove the line feed boundary state of the text paragraph. If occurrence of the line feed boundary state in the text paragraph is not detected, the preset property does not need to be applied to the text paragraph.

The preset property may be a CSS property. For example, a letter-spacing property value or a Word-spacing property value of the text paragraph is a set negative value, for example, −1 pixel (px), so as to make words of the text paragraph be more compact, thereby clearing a space for accommodating more content and removing the line feed boundary state of the text paragraph.

In the implementation of detecting whether the line feed boundary state occurs in the text paragraph by using the CSS property, if it is detected that the line feed boundary state occurs in the text paragraph, the CSS property applied to the text paragraph is retained to remove the line feed boundary state of the text paragraph. If it is detected that the line feed boundary state does not occur in the text paragraph, the CSS property applied to the text paragraph is removed.

In this embodiment, by detecting whether a line feed boundary state occurs in a text paragraph of a mobile terminal and applying a preset property to the text paragraph of the mobile terminal to remove the line feed boundary state if the line feed boundary state occurs in the text, paragraph of the mobile terminal, a situation in which a last symbol individually occupies one line of the text paragraph is avoided, display interface resources of the mobile terminal are saved, and limitation to information showing of existing mobile terminals is also avoided.

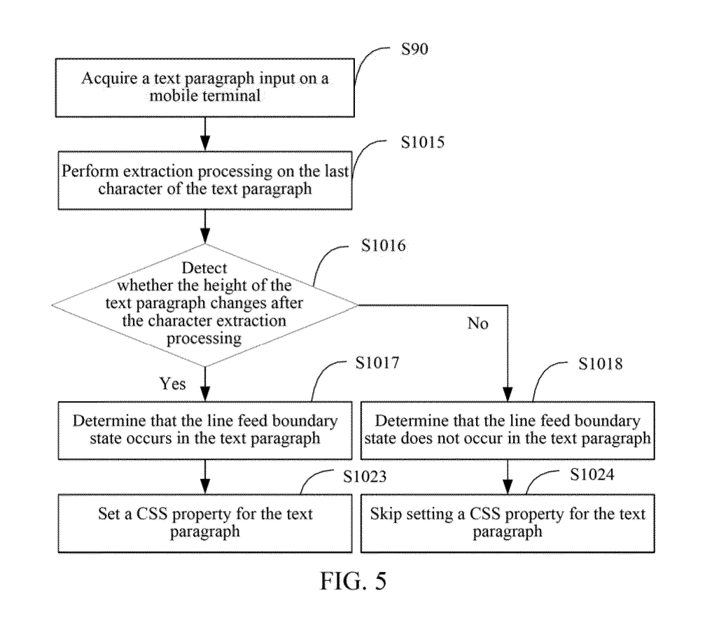

Specifically, as shown in FIG. 9, as an implementation, the detecting module 201 may include: a setting unit 2011 and a first detecting and determining unit 2012.

The setting unit 2011 is configured to set a CSS property for the text paragraph, for example, set a letter-spacing property value or a Word-spacing property value of the text paragraph to be a set negative value.

The first detecting and determining unit 2012 is configured to detect whether the height of the text paragraph changes after the CSS property is set; if the height changes, determine that the line feed boundary state occurs in the text paragraph; and otherwise, determine that the line feed boundary state does not. occur in the text paragraph.

In this implementation, the processing module 202 is further configured to retain the CSS property in the text paragraph of the mobile terminal, if the line feed boundary state occurs in the text paragraph of the mobile terminal; and otherwise, remove the CSS property.

Thus, by detecting whether a line feed boundary state occurs in a text paragraph of a mobile terminal by setting a CSS property for the text paragraph, of the mobile terminal. retaining the CSS property in the text paragraph of the mobile terminal if the line feed boundary state occurs in the text paragraph of the mobile terminal, and otherwise, removing the applied CSS property, a situation in which a last symbol individually occupies one line of the text paragraph is avoided, display interface resources of the mobile terminal are saved, and limitation to information showing of existing mobile terminals is also avoided.

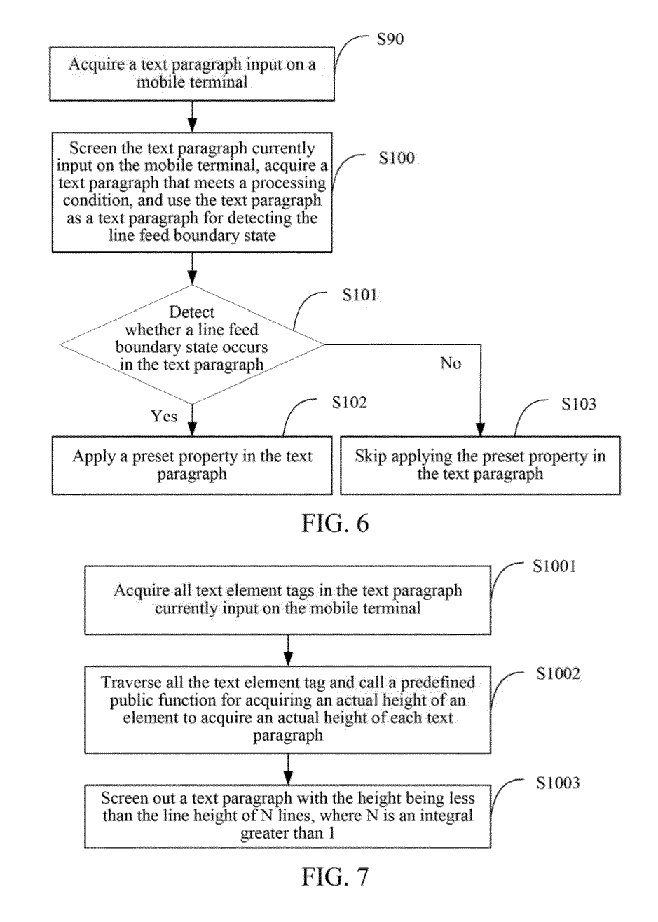

As shown in FIG. 10, as another implementation, the detecting module 201 may include: an extraction, unit 2013 and a second detecting and determining unit 2014.

The extraction unit 2013 is configured to perform extraction processing on a last character of the text paragraph.

The second detecting and determining unit 2014 is configured to detect whether the height of the text paragraph changes after the character extraction processing is performed; if the height changes, determine that the line feed boundary state occurs in the text paragraph; and otherwise, determine that the line feed boundary state does not occur in the text paragraph.

In this implementation, the processing module 202 is further configured to set a CSS property for the text paragraph of the mobile terminal when the line feed boundary state occurs in the text paragraph of the mobile terminal, for example, set a letter-spacing property value of a Word-spacing property value of the text paragraph to be a set negative value; and otherwise skip setting a CSS property for the text paragraph of the mobile terminal.

Thus, by detecting whether a line feed boundary state occurs in. a text paragraph of a mobile terminal by using a character string extraction method, applying a preset property to the text paragraph of the mobile terminal to remove the line feed boundary state, and otherwise, skipping applying the preset property, a situation in which a last symbol individually occupies one line of the text paragraph is avoided, display interface resources of the mobile terminal are saved, and limitation to information showing of existing mobile terminals is also avoided.

It should be noted that in the embodiment, the letter-spacing property in the implementation may be replaced with a Word-spacing property in the CSS in some situations. The Word-spacing defines the number of blank characters that are inserted between words in a text element. With respect to the property, “word” is defined as a character string surrounded by blank characters, if a length value is designated, a general interval between words may be adjusted. A default value of the interval is generally set to be 0.

The Word-spacing is a CSS property similar to the letter-spacing. The difference between the Word-spacing and the letter-spacing is: what is defined by the letter-spacing is a space between characters and what is defined by the Word-spacing is a space between characters (words). For pure Chinese, because there is not a blank character between Chinese characters, the Word-spacing has no effect on the Chinese. Therefore, only the letter-spacing can be used in a condition of pure Chinese.

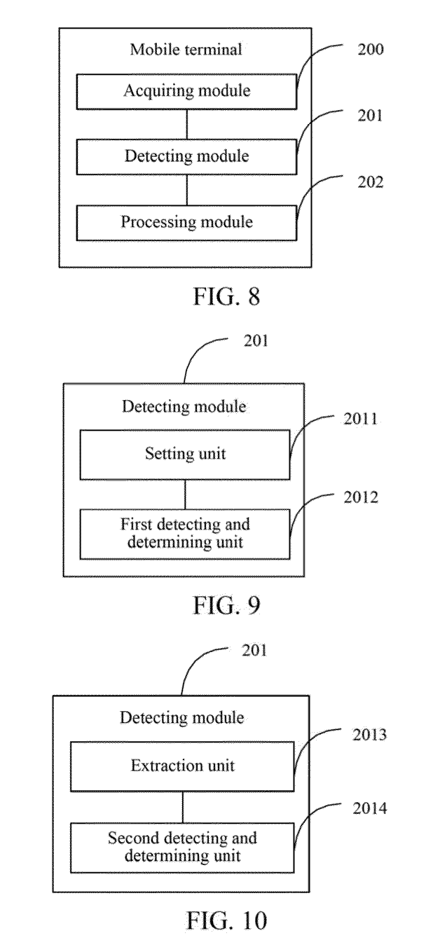

As shown in FIG. 11, a sixth embodiment of the present invention provides a text processing apparatus, which further includes a screening module 203 on the basis of the first embodiment.

The screening module 203 is configured to screen text paragraphs currently inputted on the mobile terminal, acquire a text paragraph that meets a processing condition, and use the text paragraph as a text paragraph for detecting the line feed boundary state.

In this embodiment, in consideration of that not all text paragraphs are suitable to the setting of a letter-spacing property, because reading may be influenced to a certain extent if a text is compact when there are many words of M (M is greater than 3) lines, this embodiment only processes a text paragraph that has a line feed boundary state and is of a predetermined N lines, for example, two to three lines (that is, a situation in which a last symbol individually occupies a second line or a third line).

In this embodiment, by screening text paragraphs to be detected, detecting whether a line feed boundary state occurs in a text paragraph of the mobile terminal, applying a preset property to the text paragraph of the mobile terminal if the line feed boundary state occurs in the text paragraph of the mobile terminal, and otherwise, skipping applying the preset property, a situation in which a last symbol individually occupies one line of the text paragraph is avoided, display interface resources of the mobile terminal are saved, and limitation to information showing of existing mobile terminals is also avoided.

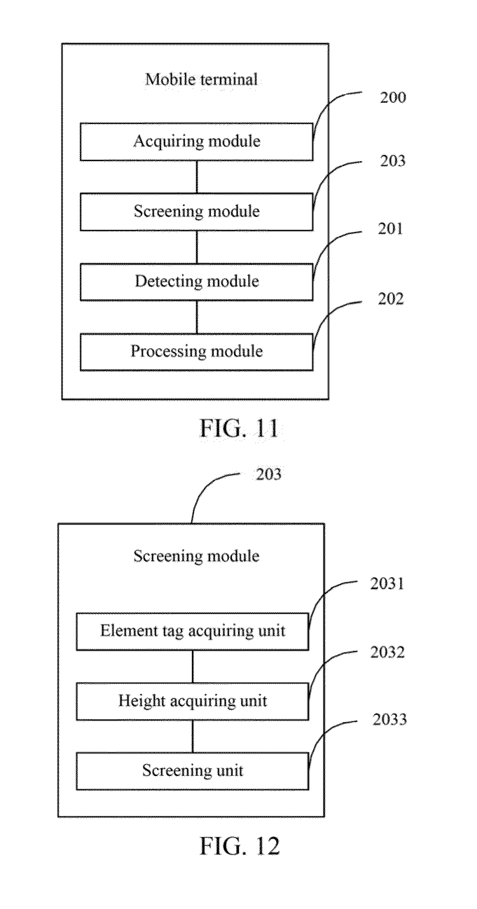

Specifically, as shown in FIG. 12, as an implementation, the screening module 203 may include: an element tag acquiring unit 2031, a height acquiring unit 2032, and a screening unit 2033.

The element tag acquiring unit 2031 is configured to acquire all text element tags of a text paragraph currently inputted on a mobile terminal.

The height acquiring unit 2032 is configured to traverse all the text element tags and call a predefined public function for acquiring an actual height of an element to acquire an actual height of each text paragraph.

The screening unit 2033 is configured to screen out a text paragraph, with the height being less than the height of N lines, where N is an integral greater than 1, for example, two or three lines may be used.

Thus, by screening a text paragraph to be detected, display interface resources of the mobile terminal may be further saved, and limitation to information showing of the mobile terminals is also avoided.

The embodiments of the present invention relate to a text processing method and a mobile terminal. By detecting whether a line feed boundary state occurs in a text paragraph of the mobile terminal, applying a preset property in the text paragraph of the mobile terminal to remove the line feed boundary state if the line feed boundary state occurs in the text paragraph of the mobile terminal, and otherwise, skipping applying the preset property, a situation in which a last symbol individually occupies one line of the text paragraph is avoided, display interface resources of the mobile terminal are saved, and limitation to information showing of existing mobile terminals is also avoided. Besides, screening may be further performed on the text paragraph to be detected before detecting whether a line feed boundary state occurs in the text paragraph of the mobile terminal, display Interface resources of the mobile terminal may be further saved and limitation to information showing of existing mobile terminals is also avoided.

The foregoing descriptions are merely preferred embodiments of the present invention but are not intended to limit the patent scope of the present disclosure. Any equivalent modifications made to the structures or processes based on the content of the specification and the accompanying drawings of the present disclosure for direct or indirect use in other relevant technical fields shall also be encompassed in the patent protection scope of the present disclosure.

What is claimed is:

1. A text processing method, comprising:
acquiring a text paragraph inputted on a mobile terminal;
detecting whether a line feed boundary state in which line feed is caused by a last character and a last line is occupied by the character occurs in the text paragraph, when displaying the text paragraph in a set display area; and
applying a preset property to the text paragraph to remove the line feed boundary state if the line feed boundary state occurs in the text paragraph.

2. The method according to claim 1, wherein the step of detecting whether a line feed boundary state in which line feed is caused by a last character and a last line is occupied by the character occurs in the text paragraph when displaying the text paragraph in a set display area comprises:
setting a CSS property for the text paragraph;
detecting whether the height of the text paragraph changes after the CSS property is set;
when it is detected that the height changes, determining that the line feed boundary state occurs in the text paragraph; and
when it is detect that the height does not change, determining that the line feed boundary state does not occur in the text paragraph,

3. The method according to claim 2, wherein the step of applying a preset property to the text paragraph to remove the line feed boundary state if the line feed boundary state occurs in the text paragraph comprises:
retaining the CSS property in the text paragraph if the line teed boundary state occurs in the text paragraph; and
removing the CSS property if the line feed boundary state does not occur in the text paragraph.

4. The method according to claim 1, wherein the step of detecting whether a line feed boundary state in which fine feed is caused by a last character and a last line is occupied by the character occurs in the text paragraph when displaying the text paragraph in a set display area comprises:
performing extraction processing on the last character of the text paragraph;
detecting whether the height of the text paragraph changes after the character extraction processing is performed;
when it is detected that the height changes, determining that the line feed boundary state occurs in the text paragraph; and
when it is detected that the height does not change, determining that the line feed boundary state does not occur in the text paragraph.

5. The method according to claim 4, wherein the step of applying a preset property to the text paragraph if the line feed boundary state occurs in the text paragraph of the mobile terminal comprises:
setting a CSS property for the text paragraph if the line feed boundary state occurs in the text paragraph of the mobile terminal.

6. The method according to claim 5, the step of setting a CSS property for the text paragraph comprises:
setting a letter-spacing property value or a Word-spacing property value of the text paragraph to be a set negative value.

7. The method according to claim 6, wherein the set negative value is −1 pixel.

8. The method according to claim 1, wherein after the step of acquiring a text paragraph input on a mobile terminal, the method further comprises:
screening text paragraphs currently inputted on the mobile terminal;
acquiring a text paragraph that meets a processing condition; and
using the text paragraph meeting the processing condition as a text paragraph for detecting the line feed boundary state.

9. The method according to claim 8, wherein the step of screening the text paragraph currently input on the mobile terminal and acquiring a text paragraph that meets a processing condition comprises:
acquiring all text element tags in the text paragraph currently inputted on the mobile terminal;
traversing all the text element tags and calling a predefined public function for acquiring an actual height of an element to acquire an actual height of each text paragraph; and
screening out a text paragraph with the height being 2 or 3 lines.

10. A mobile terminal, comprising;
an acquiring module configured to acquire a text, paragraph input on the mobile terminal;
a detecting module configured to detect whether a line feed boundary state in which line feed is caused by a last character and a last line is occupied by the character occurs in the text paragraph when displaying the text paragraph in a set display area; and
a processing module configured to apply a preset property to the text paragraph to remove the line feed boundary state if the line feed boundary state occurs in the text paragraph.

11. The mobile terminal according to claim 10, wherein the detecting module comprises:
a setting unit configured to set a CSS property for the text paragraph; and
a first detecting and determining unit configured to:
detect whether the height of the text paragraph changes after the CSS property is set;
if the height changes, determine that the line feed boundary state occurs in the text paragraph; and
if the height does not change, determine that the line feed boundary state does not occur in the text paragraph.

12. The mobile terminal according to claim 11, wherein the setting unit is further configured to set a letter-spacing property value or a Word-spacing property value of the text paragraph to be a set negative value.

13. The mobile terminal according to claim 11, wherein the processing module is further configured to:
retain the CSS property in the text paragraph if the line feed boundary state occurs in the text paragraph; and
remove the CSS property if the line feed boundary state does not occur in the text paragraph.

14. The mobile terminal according to claim 10, wherein the detecting module comprises:
an extraction unit, configured to perform extraction processing on a last character of the text paragraph; and
a second detecting and determining unit configured to:
detect whether the height of the text paragraph changes after the character extraction processing is performed:
if the height changes, determine that the line feed boundary state occurs in the text paragraph; and
if the height does not change, determine that the line feed boundary state does not occur in the text paragraph.

15. The mobile terminal according to claim 14, wherein the processing module is further configured to;
set a CSS property for the text paragraph if the line feed boundary state occurs in the text paragraph; and
skip setting a CSS property for the text paragraph if the line feed boundary state does not occur in the text paragraph.

16. The mobile terminal according to claim 15, wherein the processing module is further configured, to set a letter-spacing property value or a Word-spacing property value of the text paragraph to be a set negative value.

17. The mobile terminal according to claim 16, wherein the set negative value is −1 pixel.

18. The mobile terminal according to claim 14, further comprising:
a screening module configured to screen the text paragraph currently input on the mobile terminal, to acquire a text paragraph that meets a processing condition, and to use the text paragraph meeting the processing condition as a text paragraph for detecting the line feed boundary state.

19. The mobile terminal according to claim 18, wherein the screening module comprises:
an element tag acquiring unit configured to acquire all text element tags of the text paragraph currently input on the mobile terminal;
a height acquiring unit configured to traverse all the text element tags and call a predefined public function for acquiring an actual height of an element to acquire an actual height of each text paragraph; and
a screening unit, configured to screen, out a text paragraph with the height being 2 or 3 lines.
